(19) United States
(12) Patent Application Publication
(10) Pub. No.: US 2026/0214388 A1
(43) Pub. Date: Jul. 23, 2026

(54) DIAPHRAGM FOR MICROSPEAKER AND RELATED PROCESSES

(71) Applicant: 3M INNOVATIVE PROPERTIES COMPANY, St. Paul, MN (US)

(72) Inventors: Junyi Yang, Shanghai (CN); Jiangdong Tong, London (CA); Mary E. Johansen, Woodbury, MN (US); Jacob D. Yound, St. Paul, MN (US); Shaun M. West, St. Paul, MN (US); Christopher J. Rother, Hudson, WI (US); Ingrid N. Haugan Smidt, Woodbury, MN (US); Barbara L. Kellen, Baldwin, WI (US); Troy J. Anderson, Afton, MN (US)

(21) Appl. No.: 19/139,236

(22) PCT Filed: Dec. 16, 2022
(86) PCT No.: PCT/CN2022/139516

§ 371 Date: Jun. 13, 2025

(51) Int. Cl. H04R 7/10; H04R 31/00

(52) U.S. Cl. CPC H04R 7/10; H04R 31/003; H04R 2307/025

(57) ABSTRACT

A diaphragm for a microspeaker has an organic polymer film layer in direct contact with one or two skin layers. The one or two skin layers independently include a block copolymer having hard segments and soft segments, in which a portion of the hard segments is included in crystalline, physical crosslinking domains. The organic polymer film layer is not tacky at 25° C. A process of making the diaphragm is also described. The process includes coextruding the block copolymer and an organic polymer to provide a multilayer film comprising the one or two skin layers and the organic polymer film layer in direct contact with the one or two skin layers. A microspeaker including the diaphragm is also described.

### BACKGROUND

Microspeakers can be found in small electronics, for example, cell phones, tablets, earbuds, headphones, and laptop computers. In a microspeaker, a voice coil causes a diaphragm to vibrate under the effect of an electromagnetic force, which then pushes air to produce sound.

U.S. Pat. No. 10,856,083 (Cheng et al.) and U.S. Pat. Appl. Pub Nos. 20210120340, 20210258707, and 20210266672 (each to Wang et al.) describe multilayer diaphragms including thermoplastic elastomer layers and an adhesive layer. The adhesive layer is required to have adhesion properties.

Int. Pat. Appl. Pub. Nos. WO 2021/186276 and WO 2021/186277 (each to Yang et al.) describe single-layer or multilayer diaphragms comprising chemically crosslinked thermoplastic polyester elastomers and chemically crosslinked thermoplastic polyurethane elastomers, respectively. For multilayer diaphragms, the chemically crosslinked thermoplastic elastomer layers are separated by one or more damping adhesive layers.

### SUMMARY OF THE INVENTION

In one aspect, the present disclosure provides a diaphragm for a microspeaker having an organic polymer film layer in direct contact with one or two skin layers. The one or two skin layers independently include a block copolymer having hard segments and soft segments, in which a portion of the hard segments is included in crystalline, physical crosslinking domains. The organic polymer film layer is not tacky at 25° C.

In another aspect, the present disclosure provides a diaphragm for a microspeaker having an organic polymer film layer in direct contact with and coextruded with one or two skin layers. The one or two skin layers independently include a block copolymer having hard segments and soft segments, in which a portion of the hard segments is included in crystalline, physical crosslinking domains.

In another aspect, the present disclosure provides a diaphragm for a microspeaker having an organic polymer film layer in direct contact with one or two skin layers. The one or two skin layers independently include a block copolymer having hard segments and soft segments, in which a portion of the hard segments is included in crystalline, physical crosslinking domains. The organic polymer film layer comprises a second block copolymer having second hard segments and second soft segments, wherein a portion of the second hard segments is included in crystalline, physical crosslinking domains. The second soft segments are the same as the soft segments in the block copolymer in at least one of the one or two skin layers. The organic polymer film layer has a lower modulus than the one or two skin layers.

In another aspect, the present disclosure also provides a process for making the diaphragm of any of the above aspects. The process includes coextruding the block copolymer and an organic polymer to provide a multilayer film comprising the one or two skin layers and the organic polymer film layer in direct contact with the one or two skin layers.

Two skin layers may be in direct contact with the organic polymer film layer on opposite sides of the organic polymer film layer.

In another aspect, the present disclosure provides a microspeaker comprising the diaphragm.

In this application, terms such as “a”, “an” and “the” are not intended to refer to only a singular entity but include the general class of which a specific example may be used for illustration. The terms “a”, “an”, and “the” are used interchangeably with the term “at least one”. The phrases “at least one of” and “comprises at least one of” followed by a list refers to any one of the items in the list and any combination of two or more items in the list. All numerical ranges are inclusive of their endpoints and non-integral values between the endpoints unless otherwise stated (e.g., 1 to 5 includes 1, 1.5, 2, 2.75, 3, 3.8, 4, and 5, and the like).

The terms “first” and “second” are used in this disclosure in their relative sense only. It will be understood that, unless otherwise noted, those terms are used merely as a matter of convenience in the description of one or more of the embodiments.

As used herein, the term “acrylic” or “acrylate” includes compounds having at least one of acrylic or methacrylic groups.

The term “(meth)acrylate” with respect to a monomer, oligomer or polymer means a vinyl-functional alkyl ester formed as the reaction product of an alcohol with an acrylic or a methacrylic acid.

The term “polymer” or “polymeric” includes homopolymers and copolymers, as well as homopolymers or copolymers that may be formed in a miscible blend, e.g., by coextrusion or by reaction, including, e.g., transesterification. The term “copolymer” includes random, block, graft, and star copolymers. The term “polymer” encompasses oligomers.

The term “crosslinking” refers to joining polymer chains together by covalent chemical bonds, usually via crosslinking molecules or groups, to form a network polymer. A crosslinked polymer is generally characterized by insolubility but may be swellable in the presence of an appropriate solvent.

“Alkyl group” and the prefix “alk-” are inclusive of both straight chain and branched chain groups and of cyclic groups. In some embodiments, alkyl groups have up to 30 carbons (in some embodiments, up to 25, 20, 18, 16, or 15 carbons) unless otherwise specified. Cyclic groups can be monocyclic or polycyclic.

The above summary of the present disclosure is not intended to describe each disclosed embodiment or every implementation of the present disclosure. The description that follows more particularly exemplifies illustrative embodiments. It is to be understood, therefore, that the drawings and following description are for illustration purposes only and should not be read in a manner that would unduly limit the scope of this disclosure. The drawings are not to scale.

### BRIEF DESCRIPTION OF THE DRAWINGS

The accompanying drawing, which is incorporated herein and constitute part of this specification, illustrate some embodiments of the disclosure.

FIG. 1 shows a cross-sectional view of a multilayer diaphragm for a microspeaker having a three-layer structure according to an embodiment of the present disclosure.

### DETAILED DESCRIPTION OF THE INVENTION

Certain known products useful as diaphragms for microspeakers, including those described in the above references, are made by laminating two skin layers with an adhesive film layer in which the adhesive layer is acting as the damping core. We have found that the bonding between the skin layers and adhesive layer is usually weak, resulting a high rupture/failure rate due to delamination of finished good during extensive vibration. Lamination is usually carried out at room temperature and therefore requires an adhesive that is tacky at 25° C. Diaphragms for microspeakers are often cut to a desired shape from a multilayer film having the two skin layers and the adhesive core layer described above. When the adhesive core layer is tacky at 25° C., it can stick to the blade or die during cutting. Thus, a tacky adhesive core can require that the blade or die be cleaned periodically, adding time, waste, and expense to the process. The diaphragm of the present disclosure can avoid these problems.

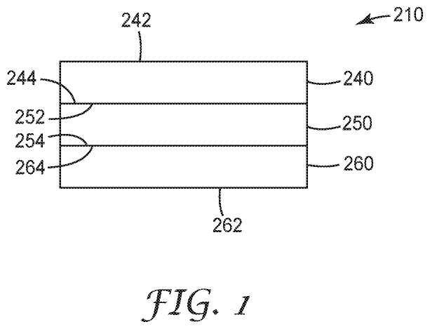

An embodiment of the diaphragm of the present disclosure is shown in FIG. 1. As shown in the schematic cross-sectional view of FIG. 1, an embodiment of a diaphragm 210 includes a first skin layer 240 (having two major surfaces 242 and 244), and an optional second skin layer 260 (having two major surfaces 262 and 264), each of which are adjacent to opposite surfaces of an organic polymer film layer 250 (having two major surfaces 252 and 254). More specifically, the first major surfaces 242 and 262 form the outer surfaces of diaphragm 210; the second major surface 244 of the first skin layer 240 is adjacent the first major surface 252 of the organic polymer film layer 250; and the second major surface 264 of the second skin layer 260 is adjacent the second major surface 254 of the organic polymer film layer 250. In some embodiments, the diaphragm further comprises one or more additional layers, in some embodiments, attached to first major surfaces 242 and 262.

In some embodiments, the diaphragm has a thickness in a range of 5 micrometers to 100 micrometers. In some embodiments, a three-layer diaphragm such as diaphragm 210 illustrated in FIG. 1 has a thickness in the range of 30 micrometers (μm) to 100 μm, 36 μm to 80 μm, or 45 μm to 65 μm. In some embodiments, first skin layer 240 and second skin layer 260 each independently has a thickness in a range of 5 μm to 30 μm, 7 μm to 20 μm, or 10 μm to 15 μm, and the organic polymer film layer 250 has a thickness in the range of 5 μm to 60 μm, 10 μm to 40 μm, or 12 μm to 30 μm.

The diaphragm for a microspeaker according to the present disclosure includes one or two skin layers independently comprising a block copolymer. The block copolymer contains hard segments and soft segments. The soft segments and uncrystallized hard segments form an amorphous phase, and a portion of the hard segment crystallizes to form crystalline microdomains, which function as physical crosslinking domains. Such block copolymers are typically known as thermoplastic elastomers, at least before any chemical crosslinking is carried out as described below. In some embodiments, the block copolymer comprises at least one of a polyester, a polyurethane, or a polyamide. Therefore, it may be at least one of a thermoplastic polyester elastomer, a thermoplastic polyurethane elastomer, or a thermoplastic polyamide elastomer, at least before any chemical crosslinking is carried out as described below. In some embodiments, the diaphragm comprises the two skin layers in direct contact with the organic polymer film layer on opposite sides of the organic polymer film layer such as in diaphragm 210 shown in FIG. 1. In the two skin layers, the block copolymers may be the same or different (i.e., they are independent selected). In some embodiments, the two skin layers comprise different block copolymers or a different combination of block copolymers.

A variety of thermoplastic polyester elastomers (TPEE) are useful for practicing the present disclosure. They can be prepared by known methods or can be obtained commercially. Soft segments in TPEEs can include polyethers or aliphatic polyester (e.g., aliphatic polyester, polytetrahydrofuran ether, polyphenylene ether, polypropylene oxide, polyethylene oxide, and combinations thereof) having a relative molecular mass in a range from 600 to 6000 grams per mole, for example. Hard segments in TPEEs can include polymers of dibasic acid (e.g., terephthalic acid, isophthalic acid, naphthalenedicarboxylic acid, biphenyldicarboxylic acid, and combinations thereof) and dihydric alcohol (e.g., ethylene glycol, propylene glycol, butylene glycol, pentanediol, hexylene glycol, and combinations thereof). Commercially available TPEEs that can be useful in the diaphragm of the present disclosure include those obtained under the trade designations “RITEFLEX” from Ticona, “HYTREL” from Du Pont De Nemours and Company, Wilmington, DE, “ECDEL” from Eastman, Kingsport, TN, “ARNITEL” from DSM, and “SUNPRENE” from Chenguang Kexin Company.

In some embodiments, the TPEE is a block copolymer composed of polyester hard segments and polyether soft segments. In some embodiments, the thermoplastic polyester elastomer is a block copolymer composed of crystalline hard segments of polybutylene terephthalate (PBT) and polyether soft segments based on a long-chain polytetrahydrofuran. Examples of suitable thermoplastic polyester elastomers including these structures include those obtained from Du Pont De Nemours and Company under the trade designations “HYTREL 3078”, “HYTREL 5556”, “HYTREL 6356”, “HYTREL 7246”, and “HYTREL 8238”. A further suitable thermoplastic polyester elastomer includes that obtained from Shibata Company under the trade designation “TPEE D63”.

A variety of thermoplastic polyurethane elastomers (TPU) are useful for practicing the present disclosure. They can be prepared by known methods or can be obtained commercially. A TPU is a thermoplastic block copolymer composed of a soft segment and a hard segment alternately connected, wherein the hard segment is an isocyanate segment (e.g., including an aliphatic isocyanate segment, an aromatic isocyanate segment, or a combination thereof), and the soft segment is a polyether polyol segment or a polyester polyol segment. The polyether polyol segments and polyester polyol segments can be any of these described above for a TPEE. In addition to the ratio of the hard segment and the soft segment, the types of the isocyanate, the polyether polyol, and the polyester polyol also affect the properties of TPU. TPU molecules are substantially linear, and TPUs have some physical crosslinking, usually through the interaction between urethane groups in the molecules. Commercially available TPUs that can be useful in the diaphragms of the present disclosure include those obtained from BASF Company, Ludwigshafen, Germany, under the trade designation “ELASTOLLANE”, from Covestro Company under the trade designation “DESMOPAN”, and TPU films produced by Shibata Company.

A variety of thermoplastic polyamide elastomers are useful for practicing the present disclosure. They can be prepared by known methods or can be obtained commercially. In a thermoplastic polyamide elastomer, the soft segment can be a polyether polyol segment or a polyester polyol segment such as any of these described above for a TPEE. Thermoplastic polyamides are commercially available, for example, under the trade designation “PEBAX” from Avient, Avon Lake, OH.

In some embodiments, the one or two skin layers comprise an inorganic filler. Any filler commonly known to those skilled in the art may be used in the context of the present disclosure. Examples of suitable filler that can be used include zeolites, clay fillers, glass beads, silica type fillers, hydrophobic silica type fillers, hydrophilic silica type fillers, fumed silica, fibers, in particular glass fibers, carbon fibers, graphite fibers, silica fibers, ceramic fibers, hollow ceramic microspheres, nanoparticles, in particular silica nanoparticles, and combinations thereof. Other additives may optionally be included in the one or two skin layers to achieve any desired properties. Examples of such additives include pigments, toughening agents, reinforcing agents, fire retardants, antioxidants, and various stabilizers. The additives are added in amounts sufficient to obtain the desired end properties. In some embodiments, fillers may be present in the one or two skin layers in an amount of up to 10, 7.5, 5, or 2.5 wt. %, based on the total weight of the respective layer.

The diaphragm for a microspeaker according to some embodiments of the present disclosure includes an organic polymer film layer in direct contact with the one or two skin layers comprising the block copolymer, wherein, in some embodiments, the organic polymer film layer is not tacky at 25° C. “Direct contact” means that there is no adhesive between the first layer and the organic polymer film layer. For the purposes of the present disclosure, the rolling ball test can be useful for determining the tacticity of a material. As described in the Examples below, non-tacky organic polymer films can be defined by a ball rolling off them in the rolling ball test at 25° C.

A variety of organic polymer film layers are useful for practicing the present disclosure. They can be prepared by known methods or can be obtained commercially. In some embodiments, the organic polymer film layer comprises at least one of an acrylic copolymer or a second block copolymer (in some embodiments, a triblock copolymer). The second block copolymer can have hard segments and soft segments, in which a portion of the hard segments is included in crystalline, physical crosslinking domains. Useful block copolymers include those having polyester, polyurethane, or polyamide hard segments and polyether or aliphatic polyester soft segments. The soft segment can include polyethers or aliphatic polyester (e.g., aliphatic polyester, polytetrahydrofuran ether, polyphenylene ether, polypropylene oxide, polyethylene oxide, and combinations thereof) having a relative molecular mass in a range from 600 to 6000 grams per mole, for example. Further examples of useful block copolymers include styrenic block copolymers having isoprene, butadiene, or ethylene-butylene soft segments, for example, and acrylic block copolymers such as a poly(methyl methacrylate)-poly(n-butyl methacrylate-poly(methyl methacrylate) triblock copolymer. In some embodiments, the organic polymer film layer comprises at least one of a polyamide-polyether-polyamide triblock copolymer, an acrylic copolymer, or a styrenic block copolymer. In some embodiments, the organic polymer film layer comprises a styrenic block copolymer, in some embodiments, a styrene-isoprene-styrene copolymer, styrene-butadiene-styrene copolymer, or a styrene-ethylene-butylene-styrene copolymer In some embodiments, the organic polymer film layer comprises an acrylic copolymer, in some embodiments, a poly(methyl methacrylate)-poly(n-butyl methacrylate-poly(methyl methacrylate) triblock copolymer.

In some embodiments, the organic polymer film layer comprises the second block copolymer having second hard segments and second soft segments, wherein a portion of the second hard segments are included in crystalline, physical crosslinking domains, and wherein the second soft segments are the same as the soft segments in the block copolymer in at least one of the one or two skin layers. The second block copolymer can be used in combination with any of the other materials described above as useful for the organic polymer film layer in any of their embodiments. Examples of suitable second block copolymers include those obtained from Du Pont De Nemours and Company, for example, under the trade designation “HYTREL 3078”. Including the second block copolymer in organic polymer film layer can increase the compatibility of the organic polymer film layer with the one or two skin layers.

Suitable commercially available materials useful for the organic polymer film layer include an acrylic copolymer obtained under the trade designation “ABC KURARITY LA2330” from Kuraray, Chiyoda City, Japan, a styrene-ethylene-butylene-styrene copolymer obtained under the trade designation “KRATON G1645” from Kraton, Houston, TX, a blend of polyether and polyamide obtained under the trade designation “PEBAX 3533” from Avient, Avon Lake, OH, and a thermoplastic elastomer obtained under the trade designation “VERSAFLEX 4132” from Avient.

Other acrylic copolymers useful for the organic polymer film layer include a wide variety of those made from alkyl (meth)acrylate monomers. Examples of suitable alkyl (meth)acrylates for making acrylic polymers include those represented by Formula I.

CH₂═C(R′)COOR (I)
wherein R′ is hydrogen or a methyl group and R is an alkyl group having 1 to 30, 4 to 30, 6 to 30, 8 to 30, 6 to 24, 6 to 20, 6 to 18, 8 to 24, 8 to 20, or 8 to 20 carbon atoms and may be linear or branched. Examples of suitable monomers represented by Formula I include methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, iso-pentyl (meth)acrylate, n-hexyl (meth)acrylate, iso-hexyl (meth)acrylate, octyl (meth)acrylate, iso-octyl (meth)acrylate, 2-octyl(meth)acrylate, 2-ethylhexyl (meth)acrylate, decyl (meth)acrylate, isodecyl acrylate, undecyl (meth)acrylate, n-dodecyl acrylate, lauryl (meth)acrylate, tridecyl (meth)acrylate, tetradecyl (meth)acrylate, pentadecyl (meth)acrylate, hexadecyl (meth)acrylate, heptadecyl (meth)acrylate, 2-propylheptyl (meth)acrylate, stearyl (meth)acrylate, n-nonyl (meth)acrylate, isononyl (meth)acrylate, isomyristyl (meth)acrylate, isostearyl (meth)acrylate, octadecyl (meth)acrylate, and behenyl (meth)acrylate. Suitable alkyl (meth)acrylate monomers further include mixtures of at least two or at least three structural isomers of a secondary alkyl (meth)acrylate of Formula II:

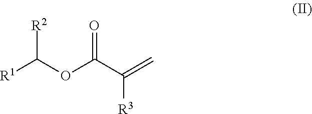

wherein R¹ and R² are each independently a C₁ to C₃₀ saturated linear alkyl group; the sum of the number of carbons in R¹ and R² is 7 to 31; and R³ is H or CH₃. The sum of the number of carbons in R¹ and R² can be, in some embodiments, 7 to 27, 7 to 25, 7 to 21, 7 to 17, 7 to 11, 7, 11 to 27, 11 to 25, 11 to 21, 11 to 17, or 11. Methods for making and using such monomers and monomer mixtures are described in U.S. Pat. No. 9,102,774 (Clapper et al.). In some embodiments, the alkyl (meth)acrylate monomers comprise at least one of 2-ethylhexyl (meth)acrylate, 2-propylheptyl (meth)acrylate, or iso-octyl (meth)acrylate.

In some embodiments, acrylic copolymers useful for the organic polymer film layer comprise monomer units of a “high T_{g}” monomer that when polymerized provides a homopolymer having a glass transition temperature (T_{g}) of at least 50° C., 60° C., or 70° C. (i.e., a homopolymer formed from the monomer has a T_{g} at least 50° C., 60° C., or 70° C.). The acrylic polymer may comprise at least 5 wt % (in some embodiments, at least 7.5, 10, 12.5 or 15 wt %) monomer units of a “high T_{g}” monomer. The T_{g} of the homopolymers are measured by Differential Scanning Calorimetry, and many are reported in the Polymer Properties Database found at polymerdatabase.com. Some suitable high T_{g} monomers include methyl methacrylate, ethyl methacrylate, n-propyl methacrylate, isopropyl methacrylate, n-butyl methacrylate, isobutyl methacrylate, sec-butyl methacrylate, tert-butyl (meth)acrylate, cyclohexyl methacrylate, isobornyl (meth)acrylate, stearyl (meth)acrylate, phenyl acrylate, benzyl methacrylate, 3,3,5 trimethylcyclohexyl (meth)acrylate, tert-butyl cyclohexyl methacrylate, 2-phenoxyethyl methacrylate, N-octyl (meth)acrylamide, tetrahydrofurfuryl methacrylate, and mixtures thereof. Other suitable high T_{g} monomers have a single vinyl group that is not a (meth)acryloyl group such as various vinyl ethers (e.g., vinyl methyl ether), vinyl esters (e.g., vinyl acetate and vinyl propionate), styrene, substituted styrene (e.g., α-methyl styrene), vinyl halide, and mixtures thereof. In some embodiments, acrylic copolymers useful for the organic polymer film layer comprise from 15 weight percent (wt %) to 50 wt % of high T_{g} monomer units, based on the total weight of the acrylic copolymer. In some embodiments, the acrylic copolymer comprises from 20 to 50 wt %, 25 to 50 wt %, from 20 to 45 wt %, or from 25 to 45 wt %, from 17 to 23 wt %, or from 17 to 20 wt % of high T_{g} monomer units, based on the total weight of the acrylic copolymer.

In some embodiments, acrylic copolymers useful for the organic polymer film layer comprise acid monomer units or other polar monomer units. Examples of (meth)acrylic acid monomer units include those from acrylic acid, methacrylic acid, itaconic acid, maleic acid, fumaric acid, ethacrylic acid, crotonic acid, citraconic acid, cinnamic acid, beta-carboxy ethyl acrylate, and 2-methacrylolyloxyethyl succinate. Other useful acid monomer units include those from sulfonic acids (e.g., 2-sulfoethyl methacrylate, styrene sulfonic acid, 2-acrylamido-2-methylpropanesulfonic acid) and salts thereof, and phosphonic acids (e.g., vinylphosphonic acid) and salts thereof. In some embodiments, the (meth)acrylic acid monomer units are acrylic acid monomer units or methacrylic acid monomer units. (Meth)acrylic acid monomer units encompass salts of these acids, such as alkali metal salts and ammonium salts. Other useful polar monomer units include those from hydroxyl- or amino-substituted acrylates (e.g., 2-hydroxyethyl acrylate, 3-hydroxypropyl acrylate, 2-hydroxybutyl acrylate, 4-hydroxybutyl acrylate, 6-hydroxyhexyl acrylate, 8-hydroxyoctyl acrylate, 10-hydroxydecyl acrylate, 12-hydroxylauryl acrylate, (4-hydroxymethylcyclohexyl)methyl acrylate, ethoxylated hydroxyethyl methacrylate such as monomers commercially available from Sartomer under the trade designations CD570, CD571, CD572, dimethylaminoethyl acrylate, t-butylaminoethyl acrylate, aminoethyl acrylate, N,N-dimethyl aminoethyl acrylate, N,N-dimethylaminopropyl acrylate, and methacrylates of the foregoing acrylates), N-vinyl-2-pyrrolidone, N-vinyl caprolactam, cyanoethyl (meth)acrylate, acrylonitrile, maleic anhydride, and combinations thereof. In some embodiments, the polar monomer units are present in amounts up to 15 wt % based on a total weight of the acrylic copolymer. In some embodiments, the polar monomer units are present in amounts of at least 0.1 wt %, at least 0.5 wt %, at least 1 wt %, or at least 2 wt %, or even at least 3 wt %, based on the total weight of the acrylic copolymer. Accordingly, in some embodiments, the polar monomer units are present in an amount in a range of from 0.1 to 15 wt %, from 0.5 to 15 wt %, from 1.0 to 10 wt %, from 2.0 to 8.0 wt %, from 2.5 to 6.0 wt %, or from 3.0 to 6.0 wt %, based on the total weight of the acrylic copolymer. In some embodiments, the amount of polar monomer units is up to 10 weight percent or up to 5 weight percent.

At least one of a “high T_{g}” monomer or a polar monomer, including any of those described above in any of their embodiments, can be useful for increasing the cohesive strength of the resulting acrylic polymer. Including monomer units of at least one of a “high T_{g}” monomer or a polar monomer typically increases the modulus of the acrylic polymer and deceases the tack of the acrylic polymer. The amount of “high T_{g}” monomer units, polar monomer units, or a combination thereof, including any of the amounts described above, may be selected such that acrylic polymer is non-tacky.

In some embodiments, the acrylic copolymer is prepared from 45 to 65 parts 2-ethylhexyl acrylate, 2 to 8 parts N-vinylpyrrolidone, 30 to 50 parts isobornyl acrylate, 1 to 5 parts acrylic acid, 0.05 to 0.3 parts 2,2-dimethoxy-1,2-diphenylethan-1-one, 0.05 to 1 part of an antioxidant such as that obtained under the trade designation “IRGANOX 1076” from BASF Corp., Ludwigshafen, Germany, and 0.005 to 0.04 parts isooctylthioglycolate. In some embodiments, the acrylic polymer is prepared from 55 to 75 parts of an octyl acrylate isomer blend prepared as described in U.S. Pat. No. 9,102,774 (Clapper et al.), 20 to 40 parts isobornyl acrylate, 1 to 5 parts acrylic acid, 0.05 to 0.3 parts 2,2-dimethoxy-1,2-diphenylethan-1-one, 0.05 to 1 part of an antioxidant such as that obtained under the trade designation “IRGANOX 1076” from BASF Corp., and 0.005 to 0.04 parts of isooctylthioglycolate. In some embodiments, the acrylic polymer is prepared from 54 parts 2-ethylhexyl acrylate, 5 parts N-vinylpyrrolidone, 38 parts isobornyl acrylate, 3 parts acrylic acid, 0.15 parts 2,2-dimethoxy-1,2-diphenylethan-1-one, 0.4 parts of an antioxidant such as that obtained under the trade designation “IRGANOX 1076” from BASF Corp., Ludwigshafen, Germany, and 0.02 parts isooctylthioglycolate. In some embodiments, the acrylic polymer is prepared from 67 parts of an octyl acrylate isomer blend prepared as described in U.S. Pat. No. 9,102,774 (Clapper et al.), 30 parts isobornyl acrylate, 3 parts acrylic acid, 0.15 parts 2,2-dimethoxy-1,2-diphenylethan-1-one, 0.4 parts of an antioxidant such as that obtained under the trade designation “IRGANOX 1076” from BASF Corp., and 0.02 parts of isooctylthioglycolate. The intrinsic viscosities of either of these polymers can be in the range of 0.6 to 0.8, 0.6 to 0.7, around 0.646 or around 0.682. Intrinsic viscosities can be obtained using a Lauda viscometer in a water bath controlled at 27° C., to measure the flow time of 10 mL of a polymer solution (0.3 g per deciliter polymer in ethyl acetate) using a procedure described in Textbook of Polymer Science, F. W. Billmeyer, Wiley-Interscience, Second Edition, 1971, Pages 84 and 85.

Acrylic polymers useful for the organic polymer film layer may be prepared by any conventional free radical polymerization method, including solution, radiation, bulk, dispersion, emulsion, solventless, and suspension processes. Copolymers resulting from such polymerization methods may be random or block copolymers. The degree of conversion (of monomers to polymer) can be monitored during the polymerization by measuring the index of refraction of the polymerizing mixture. In some embodiments, the acrylic polymer is prepared using an essentially solventless free-radical polymerization method.

The monomer mixture may comprise a polymerization initiator, especially a thermal initiator or a photoinitiator of a type and in an amount effective to polymerize the comonomers. In a typical thermal polymerization method, a monomer mixture may be subjected to thermal energy in the presence of a thermal polymerization initiator (i.e., thermal initiators). Examples of suitable thermal initiators are those available under the trade designations “VAZO” from E. I. DuPont de Nemours Co. including “VAZO 67”, which is 2,2′-azobis(2-methylbutane nitrile), “VAZO 64”, which is 2,2′-azobis(isobutyronitrile), and “VAZO 52”, which is (2,2′-azobis(2,4-dimethylpentanenitrile), and various peroxides such as benzoyl peroxide, cyclohexane peroxide, lauroyl peroxide, and mixtures thereof.

Suitable photoinitiators include those available under the trade designations “OMNIRAD” from IGM Resins (Waalwijk, The Netherlands) and include 1-hydroxycyclohexyl phenyl ketone (“OMNIRAD 184”), 2,2-dimethoxy-1,2-diphenylethan-1-one (“OMNIRAD 651”), bis(2,4,6-trimethylbenzoyl)phenylphosphineoxide (“OMNIRAD 819”), 1-[4-(2-hydroxyethoxy)phenyl]-2-hydroxy-2-methyl-1-propane-1-one (“OMNIRAD 2959”), 2-benzyl-2-dimethylamino-1-(4-morpholinophenyl)butanone (“OMNIRAD 369”), 2-methyl-1-[4-(methylthio)phenyl]-2-morpholinopropan-1-one (“OMNIRAD 907”), and 2-hydroxy-2-methyl-1-phenyl propan-1-one (“OMNIRAD 1173”), oligo[2-hydroxy-2-methyl-1-[4-(1-methylvinyl)phenyl]propanone] obtained from IGM Resins under the trade designation “ESACURE KIP 150”, and difunctional alpha-hydroxy ketones obtained from IGM Resins under the trade designations “ESACURE ONE” and “ESACURE KIP 160” (2-hydroxy-1-[4-[4-(2-hydroxy-2-methylpropionyl)phenoxy]phenyl]-2-methylpropanone). A difunctional alpha-hydroxy ketone means that the photoinitiator includes two alpha-hydroxy ketone groups. A multifunctional alpha-hydroxy ketone means that the photoinitiator includes two or more alpha-hydroxy ketone groups. Additional suitable photoinitiators include benzyl dimethyl ketal, 2-methyl-2-hydroxypropiophenone, benzoin methyl ether, benzoin isopropyl ether, anisoin methyl ether, aromatic sulfonyl chlorides, photoactive oximes, and combinations thereof.

If desired, a chain transfer agent may be added to the monomer mixture to control the molecular weight of the acrylic polymer. Examples of useful chain transfer agents include carbon tetrabromide, alcohols, mercaptans, and mixtures thereof. In some embodiments, the chain transfer agent comprises at least one of isooctylthioglycolate or carbon tetrabromide.

In some embodiments, the one or two skin layers and the organic polymer film layer are coextruded. Coextrusion means, for the purposed of the present disclosure, the simultaneous melt processing of multiple molten streams and combination of such molten streams into a single unified structure, or coextruded film, for example, from a single extrusion die. A multilayer film of at least the one or two skin layers and the organic polymer film layer can be coextruded using any suitable type of coextrusion die and any suitable method of film making such as blown film extrusion or cast film extrusion. In some embodiments, a multilayer melt stream can be formed by a multilayer feedblock, such as that shown in U.S. Pat. No. 4,839,131 (Cloeren) or other specialized feedblock or a specialized die such as those made by Cloeren Co., Orange, TX. The feed block and die used are typically heated to facilitate polymer flow and layer adhesion, with the temperature of the die depending on the polymers used. Techniques of coextrusion are found in many polymer processing references, including Progelhof, R. C., and Throne, J. L., “Polymer Engineering Principles”, Hanser/Gardner Publications, Inc., Cincinnati, Ohio, 1993.

In some embodiments, additional layers are coextruded with the one or two skin layers and the organic polymer film layer. Referring again to FIG. 1, in some embodiments, polyolefin layers (e.g., LLDPE) may be coextruded along first major surfaces 242 and 262 of the skin layers as supporting layers during the coextrusion process. Such layers can be removed to make the diaphragm of the present disclosure.

In a useful blown film process, the block copolymer and the organic polymer useful for the one or two skin layers and organic polymer film layer, described above in any of their embodiments, are simultaneously extruded through concentric annular orifices disposed in a blown film die. The coextruded polymeric tube is inflated by pressurized air as rollers draw the tube upwards, thus causing lateral and vertical stretching of the film. The extruded multilayered tube is then continuously slit, spread open to form a flat sheet, and guided through nip rolls to produce a film comprising the one or two skin layers and the organic polymer film layer.

It should be understood that solvent-based adhesives (e.g., “PSA 6574” silicone damping adhesive, a pressure-sensitive adhesive from Momentive Company, and “3M 3567 ATT” acrylic damping adhesive, a pressure-sensitive adhesive from 3M Company, St. Paul, MN) are generally not used in coextrusion processes. Also, certain polymers such as polyetheretherketone (PEEK) are impossible to coextrude with thermoplastic elastomers (e.g., thermoplastic urethane elastomers such as any of those described above) since the extrusion temperature of PEEK is beyond 340° C. Thus, extrusion of such materials reported in WO 2021/186277 (Yang et al.) refers to extruding separate layers and laminating them together.

Lamination and coextrusion processes result in different structures at the interfaces between layers. Compatible chemistries in coextruded layers can lead to interfacial diffusion. Such interlayer diffusion is not observed in laminated layers. In embodiments in which the one or two skin layers and organic polymer film layers are coextruded, the polymeric compositions for each layer can be chosen to have similar properties such as chemical structure and melt viscosity. Compatibility of the organic polymer film layer with the one or two skin layers can improve interlayer adhesion upon coextrusion.

The organic polymer film layer generally has a lower elastic modulus than the one or two skin layers. In some embodiments, the organic polymer film layer has an elastic modulus that is at least 10, 15, 20, 25, or 50 percent lower than that of the one or two skin layers. On the other hand, in some embodiments, the organic polymer film layer has an elastic modulus that is at least 1, 2, 5, or 10 percent of that of the one or two skin layers (i.e., it is within two orders of magnitude of the elastic modulus of the one or two skin layers). The “elastic modulus” as used herein is synonymous with Young's modulus, the modulus of elasticity, and the DMT modulus.

The elastic modulus of a cross-section of a diaphragm having organic polymer film layer and one or two skin layers as well as interfacial diffusion between layers can be determined by atomic force microscopy (AFM)-based nanoindentation, for example, after embedding a sample of the diaphragm in a suitable resin such as an epoxy and obtaining a cross-section by cryo-microtomy. In AFM, a small sharp probe tip attached to the end of a cantilever is raster-scanned across a surface. The AFM cantilever bends as the tip is scanned; the cantilever bending force is described by Hooke's Law: Fc=−kx, where k is the cantilever spring constant, Fc is the force of the cantilever and x is the cantilever deflection. A method useful for determining elastic modulus employs a dynamic AFM mode called peak force tapping, where the tip is modulated so the tip and the surface are brought intermittently together. At each x-y position, the maximum force (peak force) between tip and sample is kept constant to create a three-dimensional topography map of a surface. In addition to topographic imaging, this mode acquires force-distance curves between tip and sample at each pixel of the image channel. A force-distance curve is obtained as the tip approaches towards the surface and withdraws from the surface. The Peakforce Tapping Mode used in the Examples, below, calculates the modulus using the DMT model. To determine whether the organic polymer film layer has a lower elastic modulus than the one or two skin layers, it is useful to measure the material toward the central portion of the layers, i.e., at a point within 50 percent of the total thickness of the layer disposed around the central plane of the layer.

Interfacial diffusion between layers of the diaphragm can be detected by AFM by measuring the elastic modulus toward the central portion of the organic polymer film layer, the central portion of one of the skin layers, and at the edge of the skin layer interfacing with the organic polymer film layer. The elastic modulus at the interface can be different from both the central portion of the organic polymer film layer and the central portion of one of the skin layers. Such an interface would not be detectable in a laminated sample.

In some embodiments, the organic polymer film layer has a storage modulus that is higher than a storage modulus typically observed for a pressure sensitive adhesive (PSA). In some embodiments, the storage modulus of the organic polymer film layer at 25° C. at a frequency of 1 Hz is at least 0.15 megaPascal (MPa), at least 0.2 MPA, at least 0.25 MPa, at least 0.3 MPa, or greater than 0.3 MPa as measured with a rheometer. A polymer composition with a storage modulus at or above these values tends to lose tack. Once the modulus of a polymer layer passes beyond 0.2 MPa at 1 rad/s at application temperature, it is generally considered not to be useful in a lamination process unless additional heat is introduced. Heat is detrimental for typical diaphragm lamination processes because it negatively impacts the crystallization of the skin layer, which will eventually affect acoustic performance. Thus, in some embodiments, the storage modulus of the organic polymer film layer is too high for the organic polymer film layer to be useful in a lamination process.

In some embodiments, the diaphragm has a storage modulus in a range of 50 MPa to 1000 MPa, from 75 MPa to 900 MPa, or from 85 MPa to 700 MPa. An elastic modulus in these ranges, for example, can allow the diaphragm to effectively drive air to generate sound and provide stability and consistency of the diaphragm's operation over a long time. The storage modulus is measured on the diaphragm as a whole, including the organic polymer film layer and the one or two skin layers. For the purposes of this disclosure, the modulus of the diaphragm as a whole is determined using Dynamic Mechanical Analysis according to the test method described in the Examples, below.

In some embodiments, at least one of the one or two skin layers or the organic polymer film layer is chemically crosslinked. Chemical crosslinking refers to a crosslinked network structure including chemical bonds (e.g., covalent bonds) between polymer chains in addition to or instead of the physical crosslinks typically present in thermoplastic elastomers. A chemical crosslinking treatment forms a cross-linked network structure within the block copolymer of the one or two skin layers, within the organic polymer film layer, or between the organic polymer film layer and at least one of the skin layers via chemical crosslinking points formed by covalent bonds. After chemical crosslinking, the elastomers in the one or two skin layers and optionally the organic polymer film layer no longer function as a thermoplastic even if they are formed from one or more thermoplastic elastomers. To determine whether the one or two skin layers and the organic polymer film layer are chemically crosslinked, a solubility evaluation can be performed. For the purposes of the present disclosure, chemical crosslinking is present if there are residuals left from a sample immersed in solvent and decanted according to the Solubility Test described below. A suitable solvent for the one or two skin layers is dimethyl sulfoxide. Suitable solvents for the organic polymer film layer include dimethyl sulfoxide or acetone for acrylic copolymers, and toluene for styrenic block copolymers.

In some embodiments, at least one of the one or two skin layers or the organic polymer film layer is not chemically crosslinked. In some embodiments, none of the one or two skin layers nor organic polymer film layer is chemically crosslinked. In some embodiments, none of the one or two skin layers nor the organic polymer film layer is chemically crosslinked even after the diaphragm is exposed to electron beam radiation.

The process for chemically crosslinking at least one of the one or two skin layers or the organic polymer film layer is not particularly limited and conventional methods such as electron beam radiation crosslinking, microwave radiation crosslinking, ultraviolet radiation crosslinking, and thermal crosslinking can be used. In some embodiments, at least one of the one or two skin layers or the organic polymer film layer is crosslinked by electron beam radiation. In some embodiments, at least one of the one or two skin layers or the organic polymer film layer has a crosslinkable structure in the molecule thereof (including a structure having a crosslinkable group or a structure that can be broken and cross-linked by electron beam irradiation). In some embodiments, the electron beam radiation has an energy of 100 to 300 kilo-Volt, and the diaphragm of the present disclosure is exposed to an electron beam dose of 3 Mega-rads to 12 Mega-rads so as to cause crosslinking through covalent bonds.

In some embodiments, the organic polymer film layer has a loss factor at 25° C. from 100 Hz to 10,000 Hz of at least 0.01, 0.015, 0.02, 0.03, 0.04, or 0.05, as measured by rheometry. For the purposes of the present disclosure the rheometer is a ARES-G2 Rheometer (TA Instruments, New Castle, DE). The method described in the Examples, below, may be used. The loss factor value tan 6 is calculated from the storage modulus G′ and the loss modulus G″.

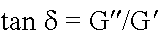

When the organic polymer film layer has a loss factor with these values, the organic polymer film layer typically provides beneficial vibration damping behavior.

In some embodiments, the diaphragm has a loss factor at 25° C. at 1000 Hz of at least 0.01, 0.015, 0.02, 0.03, 0.04, 0.05, or 0.06, as measured by Dynamic Mechanical Analysis using the method described in the Examples, below. In some embodiments, the diaphragm has a loss factor at 25° C. at 1000 Hz of up to 4, 3, 2, 1, 0.9, 0.8, 0.7, 0.6, or 0.5, as measured by Dynamic Mechanical Analysis.

The diaphragm of the present disclosure can be prepared by molding the one or two skin layers and the organic polymer film layer into a desired shape by any method known in the art. In some embodiments, the diaphragm is prepared by thermoforming. In embodiments in which chemical crosslinking treatment is carried out, thermoforming may be performed before the chemical crosslinking treatment or after the chemical crosslinking treatment. Thermoforming the diaphragm of the present disclosure can be carried out more easily than for some engineering thermoplastics typically used to make diaphragms such as PEEK since the glass transition temperature of the materials used in the diaphragm of the present disclosure is typically lower than that of such engineering thermoplastics.

In some embodiments, the diaphragm has a folded structure. One or more of any number of folded structures known to be useful for a diaphragm can be useful in the diaphragm of the present disclosure. In some embodiments, a folded structure can be beneficial to the sensitivity, consistency, and amplitude of the diaphragm.

The following list of embodiments describes some embodiments of the present disclosure.

In a first embodiment, the present disclosure provides a diaphragm for a microspeaker, the diaphragm comprising one or two skin layers independently comprising a block copolymer comprising hard segments and soft segments, wherein a portion of the hard segments is included in crystalline, physical crosslinking domains, and an organic polymer film layer in direct contact with the one or two skin layers, wherein the organic polymer film layer is not tacky at 25° C. In a second embodiment, the present disclosure provides the diaphragm of the first embodiment, wherein the one or two skin layers and the organic polymer film layer are coextruded. In a third embodiment, the present disclosure provides a diaphragm for a microspeaker, the diaphragm comprising one or two skin layers independently comprising a block copolymer comprising hard segments and soft segments, wherein a portion of the hard segments are included in crystalline, physical crosslinking domains coextruded with an organic polymer film layer in direct contact with the one or two skin layers. In a fourth embodiment, the present disclosure provides the diaphragm of any one of the first to third embodiments, wherein the organic polymer film layer comprises at least one of a second block copolymer or an acrylic copolymer, wherein the second block copolymer comprises hard segments and soft segments, wherein a portion of the hard segments is included in crystalline, physical crosslinking domains. In a fifth embodiment, the present disclosure provides the diaphragm of any one of the first to fourth embodiments, wherein the organic polymer film layer comprises the second block copolymer having second hard segments and second soft segments, wherein a portion of the second hard segments is included in crystalline, physical crosslinking domains, and wherein the second soft segments are the same as the soft segments in the block copolymer in at least one of the one or two skin layers. In a sixth embodiment, the present disclosure provides the diaphragm of any one of the first to fifth embodiments, wherein the organic polymer film layer has a lower modulus than the one or two skin layers. In a seventh embodiment, the present disclosure provides a diaphragm for a microspeaker, the diaphragm comprising one or two skin layers independently comprising a block copolymer comprising hard segments and soft segments, wherein a portion of the hard segments is included in crystalline, physical crosslinking domains and an organic polymer film layer in direct contact with the one or two skin layer, wherein the organic polymer film layer comprises a second block copolymer having second hard segments and second soft segments, wherein a portion of the second hard segments is included in crystalline, physical crosslinking domains, and wherein the organic polymer film layer has a lower modulus than the one or two skin layers. In an eighth embodiment, the present disclosure provides the diaphragm of the seventh embodiment, wherein the second soft segments are the same as the soft segments in the block copolymer in at least one of the one or two skin layers. In a ninth embodiment, the present disclosure provides the diaphragm of any one of the first to eighth embodiments, wherein the diaphragm comprises the two skin layers in direct contact with the organic polymer film layer on opposite sides of the organic polymer film layer. In a tenth embodiment, the present disclosure provides the diaphragm of any one of the first to ninth embodiments, further comprising one or more additional layers.

In an eleventh embodiment, the present disclosure provides the diaphragm of any one of the first to tenth embodiments, wherein at least one of the one or two skin layers or the organic polymer film layer is chemically crosslinked. In a twelfth embodiment, the present disclosure provides the diaphragm of any one of the first to tenth embodiments, wherein at least one of the one or two skin layers or the organic polymer film layer is not chemically crosslinked. In a thirteenth embodiment, the present disclosure provides the diaphragm of any one of the first to twelfth embodiments, wherein the block copolymer comprises at least one of a polyester, a polyurethane, or a polyamide. In a fourteenth embodiment, the present disclosure provides the diaphragm of any one of the first to thirteenth embodiments, wherein the block copolymer comprises a polyester. In a fifteenth embodiment, the present disclosure provides the diaphragm of any one of the first to fourteenth embodiments, having a loss factor of at least 0.05 at 25° C. as measured by Dynamic Mechanical Analysis. In a sixteenth embodiment, the present disclosure provides the diaphragm of any one of the first to fifteenth embodiments, wherein at least one of one or two skin layers comprises inorganic filler. In a seventeenth embodiment, the present disclosure provides the diaphragm of any one of the first to sixteenth embodiments having a thickness in a range of 5 micrometers to 100 micrometers.

In an eighteenth embodiment, the present disclosure provides the diaphragm of any one of the first to seventeenth embodiments, wherein the organic polymer film layer comprises a second block copolymer, wherein the second block copolymer comprises an acrylic triblock copolymer, a polyamide-polyether-polyamide triblock copolymer, a polyester-polyether-polyester triblock copolymer, or a styrenic block copolymer. In a nineteenth embodiment, the present disclosure provides the diaphragm of the eighteenth embodiment, wherein the styrenic block copolymer is a styrene-isoprene-styrene copolymer, styrene-butadiene-styrene copolymer, or a styrene-ethylene-butylene-styrene copolymer. In a twentieth embodiment, the present disclosure provides the diaphragm of any one of the first to nineteenth embodiments, wherein the organic polymer film layer comprises an acrylic copolymer comprising monomer units of an alkyl (meth)acrylate represented by formula

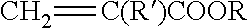

wherein R′ is hydrogen or a methyl group, and R is a linear or branched an alkyl group having 1 to 30 carbon atoms, monomer units of at least one of N-vinyl pyrrolidinone or acrylic acid, at least 20 percent by weight of monomer units of at least one high T_{g} monomer, in some embodiments, at least one of isobornyl acrylate or isobornyl methacrylate.

In a twenty-first embodiment, the present disclosure provides a process for making the diaphragm of any one of the first to twentieth embodiments, the process comprising coextruding the block copolymer and an organic polymer to provide a multilayer film comprising the one or two skin layers and the organic polymer film layer in direct contact with the one or two skin layers. In a twenty-second embodiment, the present disclosure provides the process of the twenty-first embodiment, further comprising subjecting the multilayer film to radiation. In a twenty-third embodiment, the present disclosure provides the process of the twenty-first embodiment, further comprising subjecting the multilayer film to electron beam radiation. In a twenty-fourth embodiment, the present disclosure provides the process of the twenty-third embodiment, wherein the electron beam radiation has an electron beam energy of 100 kilovolts to 300 kilovolts and an electron beam dose of 3 megarads to 12 megarads.

In a twenty-fifth embodiment, the present disclosure provides a microspeaker comprising the diaphragm of any one of the first to twentieth embodiments or made by the process of any one of the twenty-first to twenty-fourth embodiments.

Objects and advantages of this disclosure are further illustrated by the following examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples and the rest of the specification are by weight, and all reagents used in the examples were obtained, or are available, from general chemical suppliers such as, for example, Sigma-Aldrich, St. Louis, MO, or may be synthesized by conventional methods. The following abbreviations are used in this section: mm=millimeters, μm=micrometer, nm=nanometer, mL=milliliters, m=meter, kV=kilo-Volt, Mrad=Mega-rad, in =inches, g=grams, min=minute, ° C.=degrees Celsius, Hz=Hertz, kHz=kilo-Hertz, nN=nano-Newton, N=Newton, Pa=Pascal, MPa=MegaPascal, and rpm=revolutions per minute. Unless otherwise noted, all parts, percentages, ratios, etc. in the Examples and the rest of the specification are by weight. The raw materials used in the examples and comparative examples according to the present invention are as shown in Table 1 below. Unless otherwise indicated, the raw materials were used directly without additional purification.

TABLE 1
Materials Used in the Examples

| Name | Description |
|---|---|
| HYTREL 5556 | Thermoplastic polyester elastomer (medium modulus, hardness 55D), |
| | obtained under the trade designation “HYTREL 5556”, from DuPont, |
| | Wilmington, DE |
| HYTREL 7246 | Thermoplastic polyester elastomer (high modulus, hardness 72D), |
| | obtained under the trade designation “HYTREL 7426”, from DuPont |
| HYTREL 8238 | Thermoplastic polyester elastomer (highest modulus, hardness 82D), |
| | obtained under the trade designation “HYTREL 8238”, from DuPont |
| HYTREL 3078 | Thermoplastic polyester elastomer (very low modulus, hardness 32D), |
| | obtained under the trade designation “HYTREL 3078”, from DuPont |
| TRITAN FX150 | Copolyester, obtained under the trade designation “TRITAN FX150”, from |
| | Eastman |
| 611A LDPE | Low density polyethylene (LDPE), obtained under the trade designation |
| | “611A LDPE”, Dow Chemical Co., Midland, MI |
| 640i LDPE | Low density polyethylene (LDPE), obtained under the trade designation |
| | “640i LDPE”, from Dow Chemical Co. |
| PEBAX 3533 | Block copolymer elastomer, obtained under the trade designation “PEBAX |
| | 3533”, from Avient, Avon Lake, OH |
| ABC KURARITY | Acrylic block copolymer, obtained under the trade designation “ABC |
| LA2330 | KURARITY LA2330”, from Kurary, Chiyoda City, JP |
| KRATON G1645 | Styrenic block copolymer, obtained under the trade designation “KRATON |
| | G1645”, from Kraton, Houston, TX |
| VERSAFLEX 4132 | Thermoplastic elastomer, obtained under the trade designation |
| | “VERSAFLEX 4132”, from Avient |
| DMSO | Dimethyl sulfoxide, obtained from Sigma Aldrich Chemical Co., |
| | Milwaukee, WI |
| STRUERS SPECIFIX | Epoxy resin, obtained under the trade designation “STRUERS SPECIFIX |
| EPOXY | EPOXY”, from Struers, Cleveland, OH |
| Acetone | Acetone, obtained from Sigma Aldrich Chemical Co. |
| Toluene | Toluene, obtained from Sigma Aldrich Chemical Co. |

### Test Methods

### Rheology Measurements

An ARES-G2 Rheometer (TA Instruments, New Castle, DE) was used to collect all rheology data, using parallel plates of 8 mm for the head and 25 mm for the bottom plate.

Samples of the core layer only were prepared by extrusion onto a liner using a Coperion ZSK (Coperion, Stuttgart, Germany) extruder. Samples were then exposed to electron beam irradiation using a BroadBeam LE Series E-beam system with a Comet AG emitter (PCT Engineered Systems, Davenport, IA) at 180 kV and a dose of 6 Mrad. The film of the irradiated sample was then peeled off the liner, folded several times until approximately 1 mm thick. The folded sample was then put in the hot press at 180° C. and maximum pressure for 5 minutes, at which point a solid sample was formed. An 8 mm disk was then punched out and the sample loaded onto the rheometer.

Rheology temperature sweep data was then collected from −50° C. to 200° C. with a ramp rate of 3° C./min, 1% strain, 1 Hz, and 0±1.0 N compression force, under an inert atmosphere of nitrogen. The T_{g} and storage modulus (G′) at 25° C. are shown in Table 2, below.

TABLE 2
Rheometer Results for Core Layer

| Core Material | Tg, ° C. | Storage Modulus G′, Pa |
|---|---|---|
| ABC KURARITY LA 2330 | −34.4 | 195,027 |
| ABC KURARITY LA 2330/ | −34.4 | 297,051 |
| HYTREL 3078 (75/25) | | |
| KRATON G1645/HYTREL 3078 (95/5) | −34.33 | 435,860 |
| VERSAFLEX 4132 | 0.1 | 144,437 |

### Rolling Ball Test

The tacticity of core layers was determined by the rolling ball method using ASTM D3121-17. Single layer samples of the core layer only were prepared by extrusion on a Coperion ZSK (Coperion, Stuttgart, Germany) extruder. Samples were then exposed to electron beam irradiation using a BroadBeam LE Series E-beam system with a Comet AG emitter (PCT Engineered Systems, Davenport, IA) at 180 kV and a dose of 6 Mrad. The film was then cut as specified in D3121-17, and the rolling ball test was conducted per the ASTM terms. Each of the core materials shown in Table 2, above, did not exhibit any tacticity as evidenced by the rolling ball rolling off the core film.

### Dynamic Mechanical Analysis (DMA) Test

A Q800 Dynamic Mechanical Analysis (DMA) instrument (TA Instruments, New Castle, DE) was used to determine modulus and damping (tan delta) of specified films. Samples were prepared by cutting pieces approximately 6 mm wide in both the machine and transverse film directions. Samples were mounted in a tension clamp and the time-temperature superposition module was selected as the method. After the furnace was closed, the temperature was lowered to −50° C. and then held for 5 minutes. The temperature was then ramped from −50° C. to 50° C. by 10° C. intervals while the oscillation strain was held at 0.05%. For the interest of the present disclosure, storage modulus (G′), loss modulus (G″), and tan delta are the physical parameters of primary relevance.

### Solubility Test

The solubility of the film samples was analyzed to assess the chemical bonding established by e-beam crosslinking. For each sample analysis, three pieces were prepared of approximately 0.2 g to 0.3 g and placed in beakers with 20 mL of DMSO. The solutions were heated with a heating plate set to 250° C. and stirred at 600 rpm until polymer coagulated onto magnetic stirrer. After 10 minutes, while the solution was still hot, the solvent was poured into a waste container. Acetone was used to rinse the beaker and stir bar several times. Another 20 mL of acetone was added to the beaker and then placed on a cold plate while stirring in order to extract out the remaining DMSO and other soluble materials. This process was repeated and then left to sit for 1 hour. At the end of 1 hour, residuals were removed from the beaker and dried in an oven at 80° C. for 1 hour. For Examples 4 and 5, the residues from the DMSO and acetone treatments were further immersed in toluene (20 mL) while stirring for 10 mins. The filtered residues were rinsed with acetone and dried 80 C for 1 hour. The dried sample was then weighed. The surface composition of the dried sample was measured by a Nicolet iS50 FTIR Spectrometer (ThermoFisher Scientific, Waltham, MA).

### Atomic Force Microscopy (AFM) Test

Selected samples were imaged using a Bruker Dimension Icon AFM (Bruker, Billerica, MA). PeakForce Quantitative Nanomechanics (QNM) tapping technology was used to investigate nanomechanical properties including modulus.

Samples were prepared by cross-sectioning with cryo-microscopy at −60° C. The AFM probe used for analyzing the core layer was a ScanAsyst Air silicon tip with silicon nitride cantilever, 2 nm nominal radius, spring constant=0.4 N/m, and resonant frequency ~70 kHz. This tip is best suited for softer materials with a reference in the range of about 10 MPa. The tip was optimized for imaging the core by calibrating to a soft polydimethylsiloxane (PMDS) reference material having a modulus of about 10 Mpa obtained from Bruker as part of a calibration set. The AFM probe used for analyzing the skin layers was a RTESPA-150 silicon tip with silicon cantilever, 8 nm nominal radius, spring constant=5 N/m, and resonant frequency ~150 kHz. This tip is best suited for somewhat stiffer material as compared to the ScanAsyst Air probe. The tip was optimized for imaging the skin layers by calibrating to a PMDS reference material having a modulus of about 90 Mpa obtained from Bruker as part of the calibration set.

Scan areas of 5 μm×5 μm were taken at the center of each layer and at the interfaces between the skin and the core at a rate of 0.9 Hz. Larger scans were also taken across the entire skin/core/skin construction. Imaging parameters included a peak force set point of 1 nN, peak force amplitude of 75 nm, a peak force frequency of 2 kHz, integral gains of 1.5 and proportional gains of 5.0. The images were processed to remove scan lines and/or tilt. The height data was processed with 1^{st} order plane fit.

### Example 1

This film was comprised of a core of “ABC KURARITY LA2330” acrylic block copolymer and “HYTREL 5556” thermoplastic polyester elastomer as skins.

Multilayered films were produced on a Collin Lab Line 7-layer blown film line (Collin Lab and Pilot Solutions GmbH, Maitenbeth, Germany). Airflow to the die was manually controlled to achieve a blow-up ratio of about 2:1. The bubble was subsequently collapsed about 2.2 meters above the die and rolled up on a 7.6-cm (3-inch) paper core. The feed materials were supplied by 7 independent 25 mm diameter single screw extruders, each with about a 30:1 L/D. The screws feeding each layer had a compression ratio of 3:1.9 with a Maddock mixing section in layer 4. Layers 1 and 7 were LDPE 611A and layers 2 and 6 were LDPE 640i for strippable skins to help with bubble stabilization. Layers 3 and 5 contained the skin materials and layer 4 was the core material.

The processing temperatures were as follows: Layers (1,2,4,6,7) Extruder Temperature: Zone 1: 120° F. (49° C.), Zone 2: 300° F. (149° C.), Zone 3: 330° F. (165° C.), Zone 4: 380° F. (193° C.), Zone 5: 380° F. (193° C.), Zone 6: 380° F. (193° C.). Layers 3 and 5 Extruder Temperature: Zone 1: 120° F. (49° C.), Zone 2: 340° F. (171° C.), Zone 3: 360° F. (182° C.), Zone 4: 430° F. (221° C.), Zone 5: 430° F. (221° C.), Zone 6: 430° F. (221° C.). The Adaptor and Die Temperatures were as follows: Adaptor 420° F. (215° C.), Die 420° F. (215° C.).

The film thickness after stripping off LDPE skins was 50 μm to 60 μm (2 mil to 2.3 mil).

The film was exposed to electron beam irradiation in-line using a Dynamic electron-beam unit (PCT Ebeam and Integration, Davenport, IA) at 200 kV and a dose of 6 Mrad.

### Example 2

This film was comprised of a core of a 75/25 blend of “ABC KURARITY LA2330” acrylic block copolymer and “HYTREL 3078” thermoplastic polyester elastomer with “HYTREL 5556” thermoplastic polyester elastomer skins. Example 2 was prepared identically to Example 1, with the exception of the processing temperatures, which were as follows: Layers (1,2,4,6,7) Extruder Temperature: Zone 1: 120° F. (49° C.), Zone 2: 300° F. (149° C.), Zone 3: 330° F. (165° C.), Zone 4: 380° F. (193° C.), Zone 5: 380° F. (193° C.), Zone 6: 380° F. (193° C.). Layers 3 and 5 Extruder Temperature: Zone 1: 120° F. (49° C.), Zone 2: 340° F. (171° C.), Zone 3: 360° F. (182° C.), Zone 4: 430° F. (221° C.), Zone 5: 430° F. (221° C.), Zone 6: 430° F. (221° C.). The Adaptor and Die Temperatures were as follows: Adaptor 420° F. (215° C.), Die 420° F. (215° C.).

### Example 3

This film was comprised of a core of a 75/25 blend of “ABC KURARITY LA2330” acrylic block copolymer and “HYTREL 3078” thermoplastic polyester elastomer with “HYTREL 8238” thermoplastic polyester elastomer skins. Example 3 was prepared identically to Example 1, with the exception of layers 2 and 6 had 611A LDPE instead of 640i, and the processing temperatures were as follows: Layers (1,2,4,6,7) Extruder Temperature: Zone 1: 120° F. (49° C.), Zone 2: 300° F. (149° C.), Zone 3: 330° F. (165° C.), Zone 4: 380° F. (193° C.), Zone 5: 380° F. (193° C.), Zone 6: 380° F. (193° C.). Layers 3 and 5 Extruder Temperature: Zone 1: 120° F. (49° C.), Zone 2: 340° F. (171° C.), Zone 3: 360° F. (182° C.), Zone 4: 450° F. (232° C.), Zone 5: 480° F. (249° C.), Zone 6: 480° F. (249° C.). The Adaptor and Die Temperatures were as follows: Adaptor 470° F. (243° C.), Die 470° F. (243° C.).

### Example 4

This film was comprised of a core of a 95/5 blend of “KRATON G1645” styrenic block copolymer and “HYTREL 3078” thermoplastic polyester elastomer with skins of a 50/50 blend of “HYTREL 7246” thermoplastic polyester elastomer and “TRITAN FX150” copolyester. Example 4 was prepared identically to Example 1, with the exception of the processing temperatures, which were as follows: Layers (1,2,6,7) Extruder Temperature: Zone 1: 120° F. (49° C.), Zone 2: 300° F. (149° C.), Zone 3: 330° F. (165° C.), Zone 4: 380° F. (193° C.), Zone 5: 380° F. (193° C.), Zone 6: 280° F. (193° C.). Layers 3 and 5 Extruder Temperature: Zone 1: 120° F. (49° C.), Zone 2: 350° F. (177° C.), Zone 3: 390° F. (199° C.), Zone 4: 420° F. (215° C.), Zone 5: 470° F. (243° C.), Zone 6: 470° F. (243° C.). Layer 4 Extruder Temperature: 120° F. (49° C.), Zone 2: 300° F. (149° C.), Zone 3: 330° F. (165° C.), Zone 4: 380° F. (193° C.), Zone 5: 380° F. (193° C.), Zone 6: 390° F. (199° C.). The Adaptor and Die Temperatures were as follows: Adaptor 450° F. (232° C.), Die 450° F. (232° C.).

### Example 5

This film was comprised of a core of “VERSAFLEX 4132” thermoplastic elastomer and “HYTREL 5556” thermoplastic polyester elastomer skins. Example 5 was prepared identically to Example 1, with the exception that layers 2 and 6 had 640i LDPE instead of 611A, and the processing temperatures were as follows: Layers (1,2,4,6,7) Extruder Temperature: Zone 1: 120° F. (49° C.), Zone 2: 300° F. (149° C.), Zone 3: 330° F. (165° C.), Zone 4: 380° F. (193° C.), Zone 5: 380° F. (193° C.), Zone 6: 280° F. (193° C.). Layers 3 and 5 Extruder Temperature: Layers 3 and 5 Extruder Temperature: Zone 1: 120° F. (49° C.), Zone 2: 340° F. (171° C.), Zone 3: 360° F. (182° C.), Zone 4: 430° F. (221° C.), Zone 5: 430° F. (221° C.), Zone 6: 430° F. (221° C.). The Adaptor and Die Temperatures were as follows: Adaptor 420° F. (215° C.), Die 420° F. (215° C.).

Examples 1 to 5 were evaluated using the Dynamic Mechanical Analysis (DMA) and Solubility Test Methods described above. For DMA, a frequency of 1000 Hz a strain of 0.5% were used. The data at 25° C. is reported. The compositions of the core and skin layers and the results of the evaluations are given in Table 3, below.

TABLE 3
Examples 1 to 5 Compositions and Results

| | | | Storage | | | |
|---|---|---|---|---|---|---|
| | | Skin | Modulus | Tan | Residual | |
| | Core Composition | Composition | (G′), MPa | delta | wt % | FTIR of Residuals |
| 1 | ABC KURARITY | HYTREL | 112.18 | 0.09 | 0% | none |
| | LA 2330 | 5556 | | | | |
| 2 | ABC KURARITY | HYTREL | 86.3 | 0.156 | 16.7% | Thermoplastic polyester |
| | LA 2330/ | 5556 | | | | elastomer (TPEE) |
| | HYTREL 3078 | | | | | |
| | (75/25) | | | | | |
| 3 | ABC KURARITY | HYTREL | 644.77 | 0.064 | 13.6% | TPEE |
| | LA 2330/ | 8238 | | | | |
| | HYTREL 3078 | | | | | |
| | (75/25) | | | | | |
| 4 | KRATON G1645/ | HYTREL | 571.36 | 0.068 | 58.9% | Core Composition, TPEE, |
| | HYTREL 3078 | 7246/TRITAN | | | | TRITAN FX150 |
| | (95/5) | FX150 (50/50) | | | | Copolyester |
| 5 | VERSAFLEX | HYTREL | 87.8 | 0.353 | 53.8% | Polystyrene-Polyisobutylene |
| | 4132 | 5556 | | | | |

Example 2 was evaluated by AFM using the test method described above. The average modulus were measured at the center of the skin layers, the center of the core layer, and at the edge of the skin layer interfacing the core layer, and found to be 237 MPa, 18.5 MPa, and a value in between, respectively.

Those skilled in the art will understand that various modifications and changes can be made without departing from the scope of the present disclosure. Such modifications and changes are intended to fall within the scope of the invention as defined by the appended claims.

1. A diaphragm for a microspeaker, the diaphragm comprising:
one or two skin layers independently comprising a block copolymer comprising hard segments and soft segments, wherein a portion of the hard segments is included in crystalline, physical crosslinking domains, and
an organic polymer film layer in direct contact with the one or two skin layers, wherein the organic polymer film layer is not tacky at 25° C.

2. The diaphragm of claim 1, wherein the one or two skin layers and the organic polymer film layer are coextruded.

3. The diaphragm of claim 1, wherein at least one of the one or two skin layers or the organic polymer film layer is chemically crosslinked.

4. The diaphragm of claim 1, wherein at least one of the one or two skin layers or the organic polymer film layer is not chemically crosslinked.

5. The diaphragm of claim 1, wherein the block copolymer comprises at least one of a polyester, a polyurethane, or a polyamide.

6. The diaphragm of claim 1, wherein the organic polymer film layer comprises at least one of a second block copolymer having second hard segments and second soft segments, wherein a portion of the second hard segments is included in crystalline, physical crosslinking domains, or an acrylic copolymer.

7. The diaphragm of claim 6, wherein the organic polymer film layer comprises the second block copolymer having second hard segments and second soft segments, wherein the second soft segments are the same as the soft segments in the block copolymer in at least one of the one or two skin layers.

8. The diaphragm of claim 6, wherein the organic polymer film layer comprises the second block copolymer having hard segments and soft segments, wherein the second block copolymer comprises an acrylic triblock copolymer, a polyamide-polyether-polyamide triblock copolymer, a polyester-polyether-polyester triblock copolymer, or a styrenic block copolymer.

9. The diaphragm of claim 6, wherein the organic polymer film layer comprises an acrylic copolymer comprising:
monomer units of an alkyl acrylate or alkyl methacrylate represented by formula
CH₂═C(R′)COOR
wherein R′ is hydrogen or a methyl group, and R is a linear or branched an alkyl group having 1 to 30 carbon atoms;
monomer units of at least one of N-vinyl pyrrolidinone or acrylic acid; and
at least 20 percent by weight of monomer units of at least one of isobornyl acrylate or isobornyl methacrylate.

10. The diaphragm of claim 1, having a loss factor of at least 0.05 at 25° C. as measured by Dynamic Mechanical Analysis.

11. The diaphragm of claim 1, wherein at least one of the one or two skin layers comprises inorganic filler.

12. The diaphragm of claim 1, wherein the organic polymer film layer has a lower modulus than the one or two skin layers as measured by Atomic Force Microscopy.

13. A process of making the diaphragm of claim 1, the process comprising coextruding the block copolymer and an organic polymer to provide a multilayer film comprising the one or two skin layers and the organic polymer film layer in direct contact with the one or two skin layers.

14. The process of claim 13, further comprising subjecting the multilayer film to electron beam radiation.

15. The process of claim 14, wherein the electron beam radiation has an electron beam energy of 100 kilovolts to 300 kilovolts and an electron beam dose of 3 megarads to 12 megarads.

16. A microspeaker comprising the diaphragm of claim 1.

17. The diaphragm of claim 1, wherein the diaphragm comprises the two skin layers in direct contact with the organic polymer film layer on opposite sides of the organic polymer film layer.

18. The diaphragm of claim 1, further comprising one or more additional layers.

19. A diaphragm for a microspeaker, the diaphragm comprising one or two skin layers coextruded with an organic polymer film layer in direct contact with the one or two skin layers, the one or two skin layers independently comprising a block copolymer comprising hard segments and soft segments, wherein a portion of the hard segments are included in crystalline, physical crosslinking domains.

20. The diaphragm of claim 19, wherein the organic polymer film layer comprises at least one of a second block copolymer or an acrylic copolymer, wherein the second block copolymer comprises hard segments and soft segments, wherein a portion of the hard segments is included in crystalline, physical crosslinking domains.
